(19) United States
(12) Patent Application Publication
(10) Pub. No.: US 2016/0080042 A1
(43) Pub. Date: Mar. 17, 2016

(54) WIRELESS EQUIPMENT FOR AIRPLANE SEAT

(71) Applicant: ZODIAC ACTUATION SYSTEMS, Auxerre (FR)

(72) Inventor: Loic THOREUX, Courbevoie (FR)

(73) Assignee: ZODIAC ACTUATION SYSTEMS, Auxerre (FR)

(21) Appl. No.: 14/851,586

(22) Filed: Sep. 11, 2015

(30) Foreign Application Priority Data
Sep. 12, 2014 (FR) 1458593

(51) Int. Cl. H04B 7/02; B64D 11/06

(52) U.S. Cl. CPC H04B 7/02; B64D 11/06

(57) ABSTRACT

The present invention relates to equipment (80, 80A, 80B, 80C, 80D, 80E) for an airplane seat (36A) having at least two states comprising a first antenna (150A) able to transmit a state signal (158A) relative to the state of the equipment (80, 80A, 80B, 80C, 80D, 80E) and a second antenna (154A) able to receive a control signal (182) to change the state of the equipment (80A).

### CROSS-REFERENCE

This claims the benefit of the French Patent Application FR 14/58 593, filed Sep. 12, 2014 and hereby incorporated by reference herein.

### FIELD OF THE INVENTION

The present invention relates to equipment for an airplane seat. The present invention also relates to a controller for a set of equipment for one or more airplane seats, a group of at least one airplane seat module, an inner airplane space, and a communication method between the controller and equipment for an airplane seat.

### BACKGROUND OF THE INVENTION

Airplane seat equipment is for example an actuator making it possible to modify the configuration of the seat by moving movable parts of the seat, by for example causing the seat to go from a seated configuration to a reclined configuration.

In general, the airplane seat includes several pieces of equipment, in particular a power source for electrical outlets, entertainment screens, several actuators, a light source and an adjustable tablet.

The adjustable tablet is provided with a control screen allowing the passenger seated in the seat to choose several seat configurations, such as the seated or reclined configuration, as well as the intensity of the light source or the orientation of the tablet.

It is known that each seat includes a central control unit that receives signals transmitted by the tablet, and returns control signals to the equipment to provide an appropriate response as chosen by the passenger. Such communications are done using electrical wires. For example, if the passenger chooses to take the seat from a seated configuration to a reclined configuration and to turn off the light source, the tablet sends the central unit of the seat one or more signals. The central unit will analyze the signal(s) in order to return a signal to the various actuators and the light source so as on the one hand to take the seat from the seated configuration to the reclined configuration, and on the other hand take the light source from an on state to an off state.

It is also known to be able to control the seats remotely, independently from a command coming from the tablet, so as for example the return all of the seats to the seated configuration during landing or takeoff of the airplane. In that case, the central unit of each seat receives a signal in order to command all of the seats and meet the safety conditions set out during the landing and takeoff phases.

The tablet and the central unit can also send all or part of new software configurations to the equipment of one or more seats.

Furthermore, the tablet and the central unit can receive information on the state of the equipment of one or more seats via signals sent by the equipment. The state comprises statuses on the operation, internal property measurements or onboard test results.

Such devices, comprising such seats, such equipment and such control units, are for example described in patent EP 0,973,079 B1.

In both of the preceding cases, the total onboard mass of the airplane is too large.

There is therefore a need for an airplane having a decreased onboard mass.

### SUMMARY OF THE INVENTION

To that end, the invention relates to equipment including at least two states comprising a first antenna able to send a state signal relative to the state of the equipment and a second antenna able to receive a control signal to modify the state of the equipment.

According to the embodiments, the equipment according to the invention comprises one or more of the following features, considered alone or according to any possible combinations:
the equipment is an actuator.
the equipment is an actuator and the states of the equipment are different positions of the actuator.
the first antenna and the second antenna are respectively able to send and receive a signal whose frequency is greater than or equal to 800 MHz and less than or equal to 850 MHz, advantageously equal to 830 MHz.
the equipment comprises a body defining an inner volume, the first antenna and the second antenna being included in the inner volume.
the first antenna and the second antenna are the same.
the first antenna is able to receive a control signal to change the state of the equipment and the second antenna is able to send a state signal relative to the state of the equipment, each of the two antennas being different, the equipment further including a member for detecting the operating state of each antenna and a member for selecting an antenna able to select one of the two antennas based on the operating state of each antenna.

The invention also relates to a controller for a set of equipment for airplane seats, the set including at least one piece of equipment as previously described. The controller includes a third antenna able to receive one or more state signals relative to the state of the equipment and a signal requesting a change of the state of the equipment, a control unit able to generate control signals for changing the state of the equipment based on the state signals received by the third antenna, and a fourth antenna able to send one or more control signals to modify the state of the equipment.

The invention also relates to a group of seat modules, each seat module comprising at least two seats, the group including a single controller as previously described.

The invention also relates to an inner airplane area including at least two seat modules, each seat module comprising at least two seats, and one or two controllers as previously described.

The invention also relates to a communication method between a controller, the controller including a third antenna, a control unit and a fourth antenna, and equipment of a seat having at least two states and comprising a first antenna and a second antenna. The method comprises the following steps:
transmitting a state signal relative to the state of the equipment via the first antenna of the equipment;
receiving the state signal via the third antenna of the controller and a signal requesting a change of the state of the equipment;
generating a control signal via the control unit, to modify the state of the equipment as a function of the state signal and of the signal requesting to change the state of the equipment received by the third antenna;
transmitting the control signal via the fourth antenna to the equipment, the control signal depending on the state signal received by the third antenna;
receiving the control signal via the second antenna of the equipment, and
changing the state of the equipment based on the control signal received by the second antenna of the equipment.

### BRIEF DESCRIPTION OF THE DRAWINGS

The invention will be better understood upon reading the following description, provided solely as an example and done in reference to the appended drawings, in which:

FIG. 1 shows a top cutaway view of an example airplane according to the invention;

FIG. 2 is a diagrammatic side view of one example seat according to the invention;

FIG. 3 is a diagrammatic side view of two seats according to the invention, and

FIG. 4 is a diagram of a flow chart illustrating an example implementation of the communication method according to the invention.

### DETAILED DESCRIPTION OF PREFERRED EMBODIMENTS

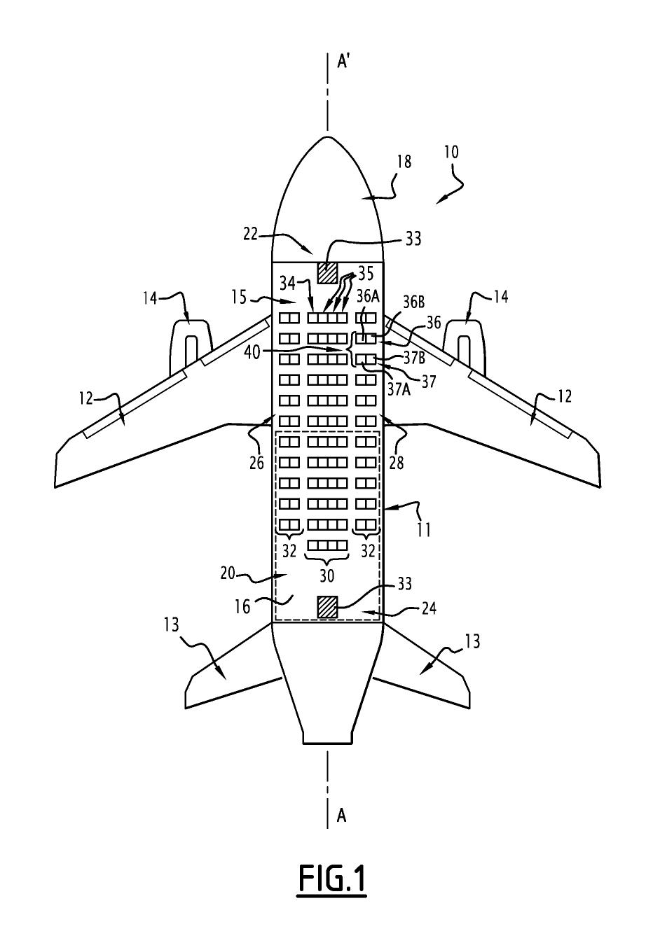

FIG. 1 shows an airplane 10. Hereinafter, the terms “front” and “rear” have the typical meaning given to them in the case of an airplane.

The airplane 10 is elongated along a direction parallel to a longitudinal axis A-A′ shown in FIG. 1. The airplane 10 comprises a central body 11, two wings 12 fastened to the central body 11 of the airplane 10, a control surface 13 and two engines 14, each engine 14 being carried by a wing 12.

The central body 11 is elongated in the longitudinal direction A-A′. The central body 11 comprises a floor 15 delimiting a lower part (not shown in FIG. 1) of the central body 11 and an upper part (not shown in FIG. 1) of the central body 11. The lower part comprises a baggage compartment 16 (shown in dotted lines in FIG. 1). The upper part comprises a cockpit 18 and an inner area 20.

The wings 12 are across from one another in a symmetrical position relative to the central body 11.

The control surface 13 is situated at the rear of the airplane. The control surface makes it possible to ensure the stability of the airplane 10 during the flight of the airplane 10.

The engines 14 are for example turbojet engines.

The cockpit 18 is situated at the front of the airplane 10. The cockpit 18 allows one or several pilots to pilot the airplane 10.

The inner space 20 extends between a front end 22 and a rear end 24.

The inner space 20 comprises two side parts 26, 28, a central row 30, at least one side row 32 of seat modules, a first controller 33 and a second controller 33.

The central row 30 extends along the longitudinal direction A-A′ between the front end 22 and the rear end 24.

The central row 30 includes several central seat modules 34 aligned behind one another along a longitudinal direction A-A′. According to the example embodiment shown in FIG. 1, each central seat module 34 includes four motorized seats 35 adjacent in a transverse direction, the transverse direction being perpendicular to the longitudinal direction A-A′ and parallel to the floor 15.

The side row 32 extends in the longitudinal direction A-A′ along the side part 26, 28. The side row 32 includes a first side seat module 36 and at least one second side seat module 37. The first side seat module 36 and the second side seat module 37 are aligned behind one another along the longitudinal direction A-A′.

According to the embodiment shown in FIG. 1, the first side seat module 36 includes a first seat 36A and a second seat 36B. The first seat 36A and the second seat 36B are motorized and are adjacent in the transverse direction.

Furthermore, the second side seat module 37 also includes a third seat 37A and a fourth seat 37B. The third seat 37A and the fourth seat 37B are motorized and are adjacent in the transverse direction.

The first side seat module 36 and the second side seat module 37 form a group 40 of seat modules.

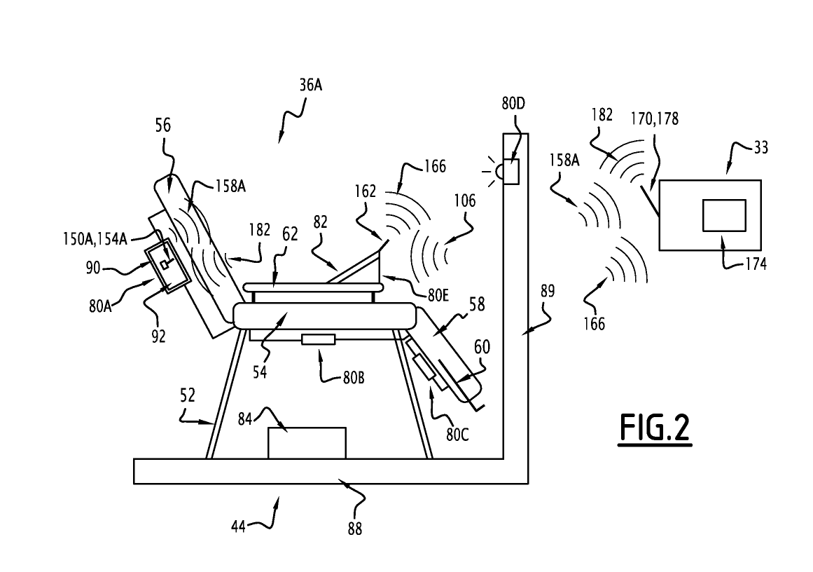

In reference to FIG. 2, only the first seat 36A is described, with the understanding that similar remarks apply to the other seats 36B, 37A and 37B.

The first seat 36A is able to receive the passenger.

The first seat 36A includes a structure 44, a leg assembly 52, a seat bottom 54, a backrest 56, a leg rest 58, a foot rest 60, and an armrest 62.

The first seat 36A further comprises a set of equipment, more simply referred to as equipment 80 hereinafter. The set of equipment 80 comprises a first piece of equipment 80A, a second piece of equipment 80B, a third piece of equipment 80C, a fourth piece of equipment 80D and a fifth piece of equipment 80E. The first seat 36A also includes a control tablet 82 for the equipment 80, a power source 84 for the equipment 80 and the control tablet 82, and electrical wires 86 connecting the power source 84 to the equipment 80.

The structure 44 is fastened on the floor 15. The structure 44 includes a base 88 and a side face 89. The structure 44 serves as a support for the first seat 36A.

The base 88 is fastened to the floor 15 along the longitudinal direction A-A′.

The side face 89 extends in a vertical direction perpendicular to the longitudinal direction A-A′ and the transverse direction. The side face 89 is fastened to the base 88 while forming a right angle with the face 88.

The leg assembly 52 is fastened to the base 88 and serves as a support for the seat bottom 54, the backrest 56, the leg rest 58 and the foot rest 60.

The seat bottom 54 rests on the leg assembly 52 along the longitudinal direction A-A′.

The backrest 56 is connected with a first end of the seat bottom 54. The backrest 56 is movable between an upright position along the vertical direction and a folded down position along the vertical direction A-A′.

The leg rest 58 is connected with a second end of the seat bottom 54. The leg rest 58 is movable between a position folded down along the vertical direction below the seat bottom 54 and a position extend along a longitudinal direction A-A′ in the extension of the seat bottom 54.

The foot rest 60 is mounted to be slidingly movable relative to the leg rest 58, between a position retracted inside the leg rest 58 and an extended position, in which the foot rest 60 extends the leg rest 58 and is practically completely deployed from the leg rest 58.

The armrest 62 rests on the seat bottom 54 in the longitudinal direction A-A′.

The pieces of equipment 80 each include a body 90 defining an inner volume 92.

The first piece of equipment 80A is mounted between the seat bottom 54 and the backrest and is able to see to the movement of the backrest 56 between the raised position and the folded down position.

The second piece of equipment 80B is mounted between the seat bottom 54 and the leg rest 58 and is able to see to a movement of the leg rest 58 between the folded down position and the extended position.

The third piece of equipment 80C is mounted between the leg rest 58 and the foot rest 60 and is able to see to the movement of the foot rest 60 between the retracted position and the extended position.

The first piece of equipment 80A, the second piece of equipment 80B and the third piece of equipment 80C are for example electric actuators.

The fourth piece of equipment 80D is integrated into the side face 89. The fourth piece of equipment 80D is for example a light source making it possible to light the passenger.

The fifth piece of equipment 80E is fastened on the armrest 62. The fifth piece of equipment 80E forms a support for the control tablet 82, movable between several positions, for example an extended position, in which the fifth piece of equipment 80E extends in the longitudinal direction A-A′, and an inclined position, in which the fifth piece of equipment 80E forms an angle smaller than 90° with the longitudinal direction A-A′.

The pieces of equipment 80 have at least two states. For example, the first piece of equipment 80A, the second piece of equipment 80B and the third piece of equipment 80C have at least two states corresponding to at least two different positions, for example a first position and a second position. The fourth piece of equipment 80D has several states, for example corresponding to several light intensity levels. The fifth piece of equipment 80E has several states corresponding to several positions, for example the extended position and the inclined position.

In order to simplify the description, and without changing the general nature of this description, only the first piece of equipment 80A will now be described, knowing that similar remarks apply to the second piece of equipment 80B, the third piece of equipment 80C, the fourth piece of equipment 80D and the fifth piece of equipment 80E with adapted references.

The first piece of equipment 80A includes, inside the inner volume 92, a first antenna 150A and a second antenna 154A.

Alternatively, the first antenna 150A and the second antenna 154A are comprised outside the inner volume 92 of the first piece of equipment 80A.

According to the embodiment shown in FIG. 2, the first antenna 150A and the second antenna 154A are the same.

According to another embodiment that is not shown, the first antenna 150A and the second antenna 154A are separate. Each antenna 150A and 154A is able to emit a state signal 158A relative to the state of the equipment 80A and to receive a control signal 182 to modify the state of the equipment 80A.

According to one preferred embodiment, the equipment 80A further includes a member for detecting the operating state of each of the two antennas 150A and 154A. Usually, the operating state of antenna is binary, i.e., either the antenna is able to operate or the antenna is not able to operate (failure of the antenna). The detection member is for example a computer monitoring a property of each of the antennas. As an illustration, such a property is the voltage supplying the antenna in question.

Preferably, the equipment 80A is also provided with an antenna selection member able to select one of the two antennas 150A and 154A based on the operating state of each antenna 150A and 154A. The state of each antenna 150A and 154A for example comes from the member detecting the operating state.

According to one particular case, the antenna selection member is a two-position switch making it possible to switch between two positions, a first position in which the first antenna 150A operates while the second antenna 154A does not operate, and a second position in which the second antenna 154A operates while the first antenna 150A does not operate.

In such a particular case, the first antenna 150A is a primary antenna that operates by default. The expression “operates by default” means that the primary antenna 150A is the antenna that is used during normal operation. The second antenna 154A is a backup antenna used only if the first antenna 150A fails.

The first antenna 150A is able to emit a state signal 158A relative to the state of the first piece of equipment 80A.

The state signal 158A can be received and interpreted by one of the controllers 33.

The state signal 158A is an electromagnetic wave that can be transmitted aerially. Aerially means that the signal propagates in the air without a wired connection.

The frequency of the state signal 158A is comprised in the radio range, i.e., the frequency of the state signal 158A is greater than or equal to 3 Hz, and less than or equal to 300 GHz.

The frequency of the state signal 158A is greater than or equal to 800 MHz, and less than or equal to 850 MHz.

Advantageously, the frequency of the state signal 158A is chosen to be as non-harmful as possible, for example comprised between 820 MHz and 840 MHz. A frequency is considered to be less harmful compared to another frequency if the considered frequency causes less damage to humans than the other frequency. Preferably, such a harmfulness comparison is done for a same amplitude of the two signals. Furthermore, the damage, according to one particular case, is potential damage. In such a case, the damage is comparable to the risk incurred by the human being. Typically, over the long term, a frequency may risk causing deafness. This is considered to be damage in the aforementioned context.

The second antenna 154A is able to receive and interpret a signal coming from the controller 33.

The control tablet 82 comprises an antenna 162 able to emit a change request signal 166.

The control tablet 82 makes it possible to control each piece of equipment 80. Only its interaction with the first piece of equipment 80A is outlined below. The control tablet 82 for example makes it possible to change the configuration of the first seat 36A. The configuration of the first seat 36A is for example a seated configuration or a reclined configuration. In the seated configuration, the leg rest 58 is in the folded down position, the backrest 56 is in the raised position, and the foot rest 60 is in the position retracted inside the leg rest 58. In the extended configuration, the leg rest 58 is in the extended position, the seat bottom 56 is in the folded down position, and the foot rest 60 is in the extended position.

The change request signal 166 can be received and interpreted by the controller 33.

The change request signal 166 is an electromagnetic wave that can be transmitted aerially.

The frequency of the change request signal 166 is comprised in the radio range.

The frequency of the change request signal 166 is greater than or equal to 800 MHz, and less than or equal to 850 MHz.

Advantageously, the frequency of the change request signal 166 is chosen to be as non-harmful as possible, for example comprised between 820 MHz and 840 MHz.

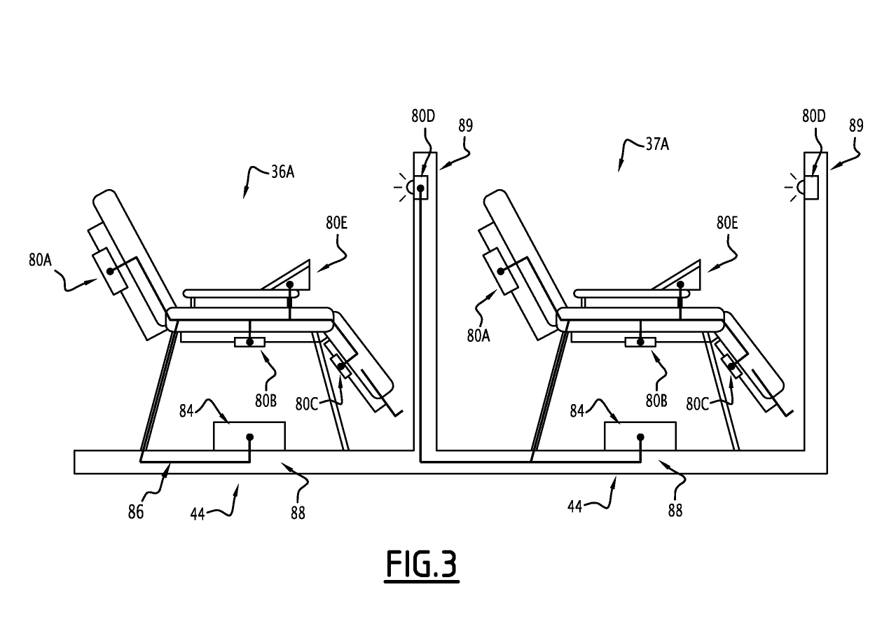

In reference to FIG. 3, the power source 84 is separately connected to the first piece of equipment 80A, the second piece of equipment 80B, the third piece of equipment 80C and the fifth piece of equipment 80E by means of electrical wires 86.

The power supply 84 of the third seat 37A is suitable for supplying electricity to at least one of the pieces of equipment 80 of the first seat 36A.

Advantageously, and as shown in FIG. 3, the power supply 84 of the third seat 37A of the second side seat module 37 is suitable for supplying electricity to the fourth piece of equipment 80D of the first seat 36A of the first side seat module 36. Indeed, the distance separating the power source 84 of the third seat 37A from the fourth piece of equipment 80D of the first seat 36A is shorter than the distance separating the power supply 84 of the first seat 36A from the fourth piece of equipment 80D of the first seat 36A.

The first controller 33 and the second controller 33 are able to control the equipment 80 of the first seat 36A. The second controller 33 is a backup controller that is used only if the first controller 33 fails.

According to one preferred embodiment, each controller 33 is a computer.

In the example embodiment shown in FIG. 1, the first controller 33 is installed at the front end 22, and the second controller 33 is installed at the rear end 24.

Alternatively, the inner space 20 only includes one controller 33.

Only the first controller 33 is described, the second controller 33 being similar.

The controller 33 includes a third antenna 170, a control unit 174 and a fourth antenna 178.

The third antenna 170 is able to receive the state signal 158 emitted by the second antenna 154A of the first piece of equipment 80A and the change request signal 166 emitted by the antenna 162 of the control tablet 82.

The control unit 174 makes it possible to analyze the state signal 158 and the change request signal 166 received by the third antenna 170.

The fourth antenna 178 is able to emit a control signal 182.

The control signal 182 can be received and interpreted by the second antenna 154A.

The control signal 182 contains instructions relative to the state of the equipment 80. Depending on the case, the instructions seek to keep or modify the state of the equipment 80 in question.

The control signal 182 is an electromagnetic wave able to be transmitted aerially.

The frequency of the control signal 182 is comprised in the radio range.

The frequency of the control signal 182 is greater than or equal to 800 MHz, and less than or equal to 850 MHz.

Advantageously, the frequency of the control signal 182 is substantially equal to 830 MHz.

Alternatively, the controller 33 is suitable for communicating with the equipment 80 of the first seat 36A, the second seat 36B, the third seat 37A and the fourth seat 37B.

In one preferred embodiment, the controller 33 is suitable for communicating with the equipment 80 of all of the seat modules 34, 36, 37 of the inner space 20.

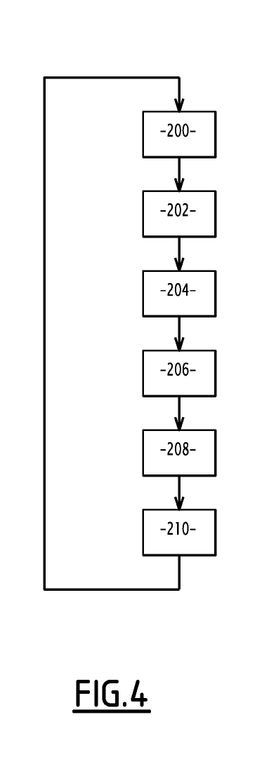

One operating example of the different elements of the inner space 20 interacting with one another will now be described. To that end, reference is in particular made to a communication method between the controller 33 and the first piece of equipment 80A of the first seat 36A as illustrated by the flowchart of FIG. 4.

The communication method includes a step 200 for transmitting a state signal 158A.

The transmission step 200 is carried out by the first antenna 150A of the first piece of equipment 80A.

The state signal 158A contains information relative to the state of the first piece of equipment 80A. According to the considered example, the information relative to the state of the first piece of equipment 80A makes it possible to know that the first piece of equipment 80A is in the first position (seatback 56 in the upright position).

The state signal 158A is transmitted aerially at a frequency advantageously equal to 830 MHz.

The communication method includes a step 202 for receiving the state signal 158A.

The third antenna 170 of the first controller 33 receives the state signal 158A.

Furthermore, the first controller 33 is capable of determining the origin of the state signal 158A.

Preferably, such a determination is implemented by a spatial recognition system.

The passenger installed in the first seat 36A then decides to change the position of the backrest 56 of the first seat 36A. To that end, the passenger interacts with the control tablet 82, requesting that the seatback 56 of the first seat 36A enter the reclined position.

The control tablet 82 then interprets the request from the passenger by transmitting a change request signal 166.

As before, the change request signal 166 is transmitted aerially.

The communication method also includes a step for receiving the change request signal 166.

The communication method then includes a step 204 for generating a control signal 182.

The control signal 182 depends on the state signal 158A received by the third antenna 170 and the change request signal 166.

In the case at hand, since the state (first position) of the first piece of equipment 80A is different from the state desired for the first piece of equipment 84A, i.e., the second position, the control signal 182 makes it possible to modify the state of the first piece of equipment 80A.

The generation of such a control signal 182 by the control unit 174.

The communication method then includes a step 206 for transmitting the control signal 182 via the fourth antenna 104 to the first piece of equipment 80A.

The control signal 182 is transmitted aerially.

The communication method includes a step 208 for receiving the control signal 182 by the first antenna 154A of the first piece of equipment 80A.

Lastly, the communication method includes a step 210 for modifying the state of the first piece of equipment 80A as a function of the control signal 182 received by the second antenna 154A of the first piece of equipment 80A.

In the case at hand, the first piece of equipment 80A goes from the first position to the second position. As a result, the seatback 56 of the first seat 36A enters the reclined position.

Preferably, steps 200, 202, 204, 206, 208 and 210 of the communication method are reiterated from step 200 at regular time intervals. This time interval is long enough to perform all of the computations involved in the movements of the moving parts of one or more seats 36A, 36B, 37A, 37B. Preferably, the time interval is greater than or equal to 25 milliseconds (ms) per seat 36A, 36B, 37A, 37B. Preferably, the time interval is less than or equal to 100 ms per seat 36A, 36B, 37A, 37B. For example, the time interval is equal to 50 ms per seat 36A, 36B, 37A, 37B.

The communication method has the advantage of involving only signals transmitted aerially.

Furthermore, the communication method previously described is simultaneously applicable to several pieces of equipment 80 of the first seat 36A.

The communication method previously described is also simultaneously applicable to the pieces of equipment 80 of at least one seat 36A, 36B of the first side seat module 36, and at least one seat 37A, 37B of the second side seat module 37.

Advantageously, the communication method previously described makes it possible to control all of the equipment 80 of all of the seat modules of the airplane 10.

The airplane 10 has the advantage of having a decreased mass relative to the airplanes described in the state of the art. Indeed, the transmission of signals between the equipment and the control tablets of the seats of the seat modules of the airplane on the one hand, and the controller(s) on the other hand, is done wirelessly.

Furthermore, only one or two controllers 33 are involved in the centralized control of the equipment 80 of all of the seats 36A, 36B, 37A and 37B of the airplane 10. Mass savings are thus achieved on all of the wires that are no longer used in the case of wireless transmission, and on the number of controllers 33.

Furthermore, the absence of communication wires makes it possible to simplify the installation of the seat modules and maintenance of the inside space 20.

Furthermore, the possibility of supplying electricity to equipment 80 of a first seat 36A from the power supply of a second seat 36B when the distance between the equipment and the power source of the second seat is smaller than the distance between the equipment and the first seat, makes it possible to save a certain distance of electrical wires, and therefore mass.

Each described embodiment can be combined with another described embodiment to provide another embodiment when it is technically possible.

1. Equipment for an airplane seat having at least two states, comprising:
a first antenna able to transmit a state signal relative to the state of the equipment, and
a second antenna able to receive a control signal to change the state of the equipment.

2. The equipment according to claim 1, wherein the equipment is an actuator and the states of the equipment are different positions of the actuator.

3. The equipment according to claim 1, wherein the first antenna and the second antenna are respectively able to send and receive a signal whose frequency is greater than or equal to 800 MHz and less than or equal to 850 MHz.

4. The equipment according to claim 1, wherein the first antenna and the second antenna are respectively able to send and receive a signal whose frequency is equal to 830 MHz.

5. The equipment according to claim 1, comprising a body defining an inner volume, the first antenna and the second antenna being included in the inner volume.

6. The equipment according to claim 1, wherein the first antenna and the second antenna are the same.

7. The equipment according to claim 1, wherein the first antenna is able to receive a control signal to change the state of the equipment and the second antenna is able to send a state signal relative to the state of the equipment, each of the two antennas being different, the equipment further including a member for detecting the operating state of each antenna, and a member for selecting an antenna able to select one of the two antennas based on the operating state of each antenna.

8. A controller for a set of equipment for an airplane seat the set including at least one piece of equipment according to claim 1, the controller including:
a third antenna able to receive one or more state signals relative to the state of the equipment, and a signal requesting a change of the state of the equipment,
a control unit able to generate control signals to change the state of the equipment based on the state signals received by the third antenna, and
a fourth antenna able to receive a control signal to change the state of the equipment.

9. A group of at least one seat module, each seat module comprising at least two seats, the group including a single controller according to claim 8.

10. A group of at least two seat modules, each seat module comprising at least two seats, the group including a single controller according to claim 8.

11. An inner space of an airplane including at least two seat modules, each seat module comprising at least two seats, and one controller according to claim 8.

12. An inner space of an airplane including at least two seat modules, each seat module comprising at least two seats, and two controllers according to claim 8.

13. A communication method between a controller, the controller including a third antenna, a control unit and a fourth antenna, and equipment of a seat having at least two states and comprising a first antenna and a second antenna, the method comprising the following steps:
transmitting a state signal relative to the state of the equipment via the first antenna of the equipment;
receiving the state signal via the third antenna of the controller and a signal requesting a change of the state of the equipment;
generating a control signal via the control unit, to modify the state of the equipment as a function of the state signal and of the signal requesting to change the state of the equipment received by the third antenna;
transmitting the control signal via the fourth antenna to the equipment, the control signal depending on the state signal received by the third antenna;
receiving the control signal via the second antenna of the equipment, and
changing the state of the equipment based on the control signal received by the second antenna of the equipment.
